(19) United States
(12) Patent Application Publication
(10) Pub. No.: US 2012/0036546 A1
(43) Pub. Date: Feb. 9, 2012

(54) Apparatuses and methods for translating multiple television control protocols at the television side

(75) Inventors: James V. Mischel, JR., Seattle, WA (US); Joseph Bogdjalian, Glendale, CA (US)

(73) Assignee: Electric Mirror, LLC, Everett, WA (US)

(21) Appl. No.: 13/068,779

(22) Filed: May 18, 2011

Related U.S. Application Data
(60) Provisional application No. 61/395,897, filed on May 18, 2010.

(51) Int. Cl. H04N 7/173

(52) U.S. Cl. 725/110

(57) ABSTRACT

An apparatus includes a memory, a communications buss coupled to the memory and a processor. The processor is coupled to the communications bus and the processor is programmed to: receive a user command signal, the user command signal is initiated by a user of a television set; pass the user command signal to an external control unit (ECU); receive a television command signal from the ECU in response to the user command signal; translate the television command signal into an IM TV protocol command, wherein a translation protocol is selected for the ECU from n possible translation protocols which are stored in the memory; and transmit the IM TV protocol command to the television.

### BACKGROUND OF THE INVENTION

1. Field of Invention

The invention relates generally to commercial televisions, and more specifically to translating protocols for commercial television command data within a commercial television.

2. Art Background

Televisions that are used in commercial settings such as in hotels, restaurants, stores, etc. typically communicate with a set-top box, also known as an external control unit (ECU). Such televisions are referred to as commercial televisions or hospitality televisions. A set-top box can provide various functions related to the delivery of content to the television, i.e., video on demand (VOD), etc. For example, the set-top box can serve as the gate keeper of content to the television. In many commercial television deployments, such as many modern hotels, without set-top boxes, the televisions would not be able to receive content for display to guests.

The set-top box communicates with the television according to a predefined protocol. The protocol is used to establish a data format for commands and other communication needs between a set-top box and a television. Protocols vary between both commercial television set manufactures and among set-top box manufactures. There is no standard in the industry. Thus, if a hotel installs a particular set-top box in its hotel rooms, the hotel must use televisions that are designed to communicate with the particular set-top box. If a television is not designed for use with the particular set-top box then it will not interface properly to the hotel's content distribution system. This situation can lead to limited market choices when hotel management looks for replacement televisions or replacement set-top boxes. The situation can cause a hotel to pay more than is reasonably necessary for hardware because of the lack of communications standard between televisions and set-top boxes. This can present a problem.

Commercial television deployments can consist of hundreds of televisions within a hotel's content distribution network. Such networks can evolve over time with new wings being added subsequent to older wings, different set-top boxes can exist in such a network requiring specific televisions to be configured with an appropriate set-top box. Such requirements can complicate the hotel's network and can increase operating costs for the hotel because of the lack of flexibility between set-top boxes and televisions. This can present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1A illustrates protocol conversion, according to embodiments of the invention.

FIG. 1B illustrates two protocols for command data, according to an embodiment of the invention.

FIG. 1C illustrates a system for issuing commands to a universal television, according to embodiments of the invention.

FIG. 2 illustrates a television capable of use within a distribution network employing a general number of n command data protocols, according to embodiments of the invention.

FIG. 3 illustrates a command data protocol translation block, according to embodiments of the invention.

FIG. 4 illustrates a system for protocol translation, according to embodiments of the invention.

FIG. 5 illustrates a process for protocol translation, according to embodiments of the invention.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are described for a universal television that accomplishes protocol translation and communication with any set-top box.

As used in this detailed description of embodiments, the terms television, commercial television, and hospitality TV are used interchangeably. Also, the terms set-top box and external control unit (ECU) are used interchangeably. No limitation is implied by the use of one term in place of the other. In various examples used herein, reference is made to a deployment of televisions within a hotel. No limitation is implied by such an example set in the context of a hotel. Embodiments of the invention can be used in any setting where an ECU and television are connected.

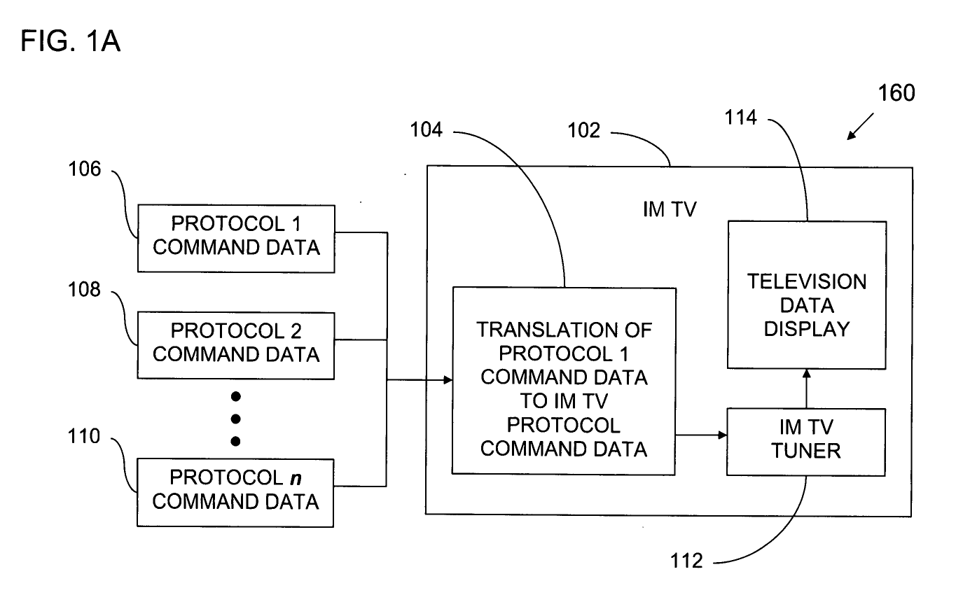

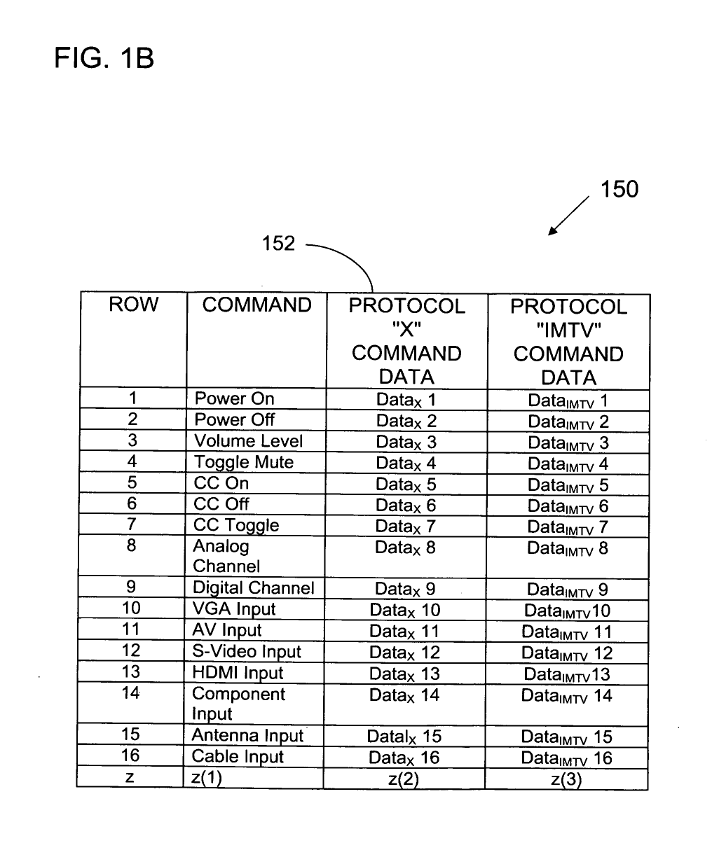

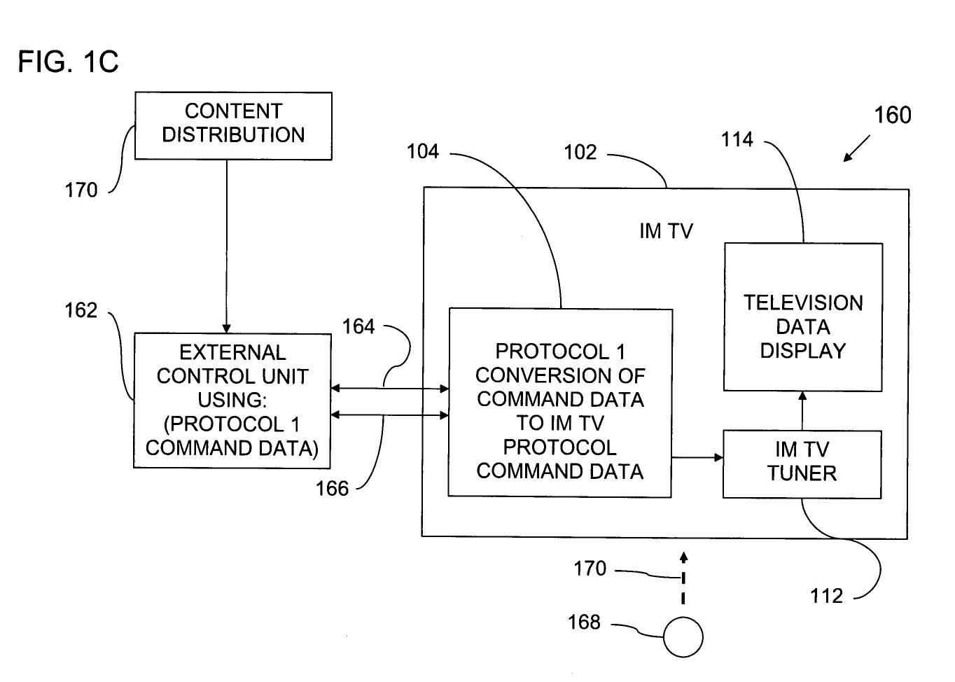

FIG. 1A illustrates, generally at 100, command data protocol translation according to embodiments of the invention. With reference to FIG. 1A, a universal television (IM TV) is indicated at 102. Resident within the universal television 102 is a protocol translation module 104, a television tuner 112, and a television data display 114. A general number of n command data protocols is represented by protocol 106, 108, through 110. The universal television 102 can respond to any one of n different protocols by configuration of protocol translation module 104.

In one embodiment, the protocol translation module 104 is set to receive command data according to protocol 1 at 106. A set-top box, not shown but described below, sends command data according to protocol 1 at 106 and is received by the protocol translation module 104. The protocol translation module 104 translates the command data sent according to protocol 1 to command data defined by IM TV protocol to the IM TV tuner at 112. The IM TV tuner responds to the IM TV command as appropriate with corresponding response to the television display at 114 if necessary. Thus, the universal television 102 can be used with any set-top box utilizing any one of n command data protocols.

FIG. 1B illustrates, generally at 150, two protocols for command data according to an embodiment of the invention. With reference to FIG. 1B, table 152 contains 16 different commands, such as: “Power On,” “Power Off,” Volume level,” . . . “Cable Input.” In one embodiment, the protocol translation module 104 (FIG. 1A) performs translations between protocol X and the IM TV protocol by translating Data_{X} 1 to Data_{IMTV} 1 when the command for “Power On” is received. A corresponding translation is performed for each of the other commands indicated in rows 2 through 16 of table 152. The translation module command suite can be expanded or updated for a given protocol. Expansion is accomplished by adding a command, for example the command z(1) indicated at row z. Under protocol X, the data representation of command z(1) is indicated at z(2) and under the IM TV protocol the data representation of command z(1) is indicated by z(3). Thus, if command z(1) were received by the protocol translation module 104 (FIG. 1A) the translation would produce command data z(3) which would perform a function associated with command z(1).

FIG. 1C illustrates, generally at 160, a system for issuing commands to a universal television according to embodiments of the invention. With reference to FIG. 1C, the universal television 102 is connected to an external control unit (ECU) 162. ECU 162 is designed to operate communicate with a television via protocol 1 for command data. The protocol translation module 104 is set to translation protocol 1 to the IMTV protocol for command data.

In operation, a user of the universal television uses a remote control indicated at 168, to send a command 170 to the universal television 102, such as a command to Power On. The universal television 102 passes the command through to the ECU 162. ECU 162 then sends the command using protocol 1 to the universal television 102. The command from ECU 162 is received by the universal television 102 via interface 164 or 168 depending on the standards used, for the ECU communication, i.e., 5 volt TTL, or 12 volt RS 232. Other interface standards can be used and embodiments of the invention are not limited thereby. When the universal television is commanded by the ECU in the scenario described above; this is referred to as external control mode.

The remote control 168 can utilize what is known in the art as an IR control, which is an abbreviation for “infrared.” Infrared indicates a segment of the electromagnetic spectrum and does not limit embodiments of the invention. An IR control is used in this description as a non-limiting example. Embodiments of the invention can be used with other remote controls using other segments of the electromagnetic spectrum or acoustic spectrum, or such controls can be hard wired.

In one embodiment, the system of FIG. 1C could be for example, a command to power on the universal television with X=1 the command data “Data₁ 1” from FIG. 1B row 1 is translated into “Data_{IMTV} 1,” from FIG. 1B by protocol translation module 104 (FIG. 1C).

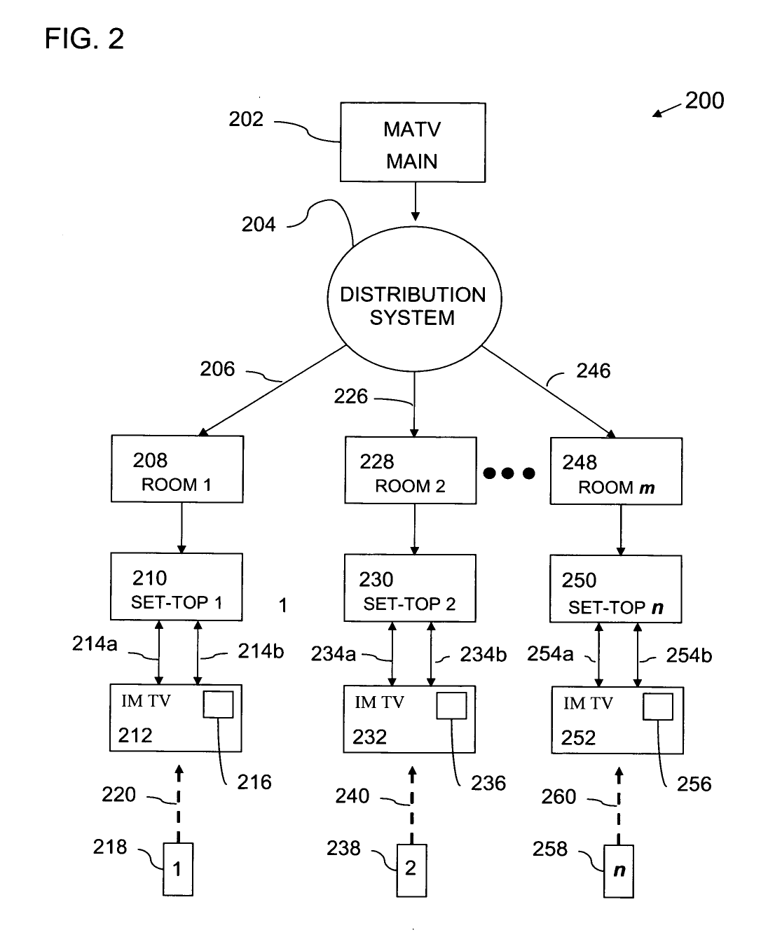

FIG. 2 illustrates, generally at 200, a universal television capable of use within a distribution network employing a general number of n command data protocols, according to embodiments of the invention. With reference to FIG. 2, a master television head end system (MATV) is indicated at 202. MATV 202 can be a source of Internet Protocol Television, it can also be a source from digital satellite head ends such as Ku band, provided by for example DirecTV and Dish Network, and or feeds from commercial cable companies. Such sources are provided by way of example and do not limit embodiments of the invention. Embodiments of the invention can be used with sources for the distribution of television content yet to be developed.

MATV 202 could be, for example, a source for a hotel's content distribution network, a source for a gym, a school, an office complex, etc. The example that follows, uses language set in a hotel setting, however no limitation is implied thereby and the hotel example is merely used to illustrate the diversity of the universal television.

MATV 202 feeds a distribution system 204. Distribution system 204 feeds at 206 a guest room indicated at 208. Guest room 208 has a set-top box 210. Set-top box 210 is connected at 214a and/or 214b to a universal television 212. Set-top box 210 utilizes command data protocol 1 and a protocol translation module 216 within universal television 212 is set to translate command data protocol 1 into command data under IM TV protocol as described above in conjunction with the previous figures. A hotel guest can use a remote control 218 to send a command 220 to make the universal television perform a function. As described above, universal television 212 passes the command 220 through to the set-top box 210. Set-top box 210 sends the command to the universal television 212 which is then translated at 216 resulting in the universal television 212 performing the desired function. Note that there can be a general number of guest rooms 208 that utilize set-top boxes which employ protocol 1 for command data. One room at 208 was used to prevent undue complexity with FIG. 2.

In the example hotel of FIG. 2, distribution system 204 provides a feed 226 to a guest room 228. Guest room 228 has a set-top box 230 utilizing protocol 2. As with guest room 208, there can be any number of guest rooms having set-top boxes configured with protocol 2, one room 228 is used to prevent undue complexity within FIG. 2.

Guest room 228 has a set-top box 230. Set-top box 230 is connected at 234a and/or 234b to a universal television 232. Set-top box 230 utilizes command data protocol 2 and a protocol translation module 236 within universal television 232 is set to translate command data protocol 2 into command data under IM TV protocol as described above in conjunction with the previous figures. A hotel guest can use a remote control 238 to send a command 240 to make the universal television perform a function. As described above, universal television 232 passes the command 240 through to the set-top box 230. Set-top box 230 sends the command to the universal television 232 which is then translated at 236 resulting in the universal television 232 performing the desired function.

In the example hotel of FIG. 2, distribution system 204 provides a feed 226 to a general number of guest rooms at 248. Guest room 228 has a set-top box 230 utilizing protocol m. As with guest room 208, there can be any number of guest rooms having set-top boxes configured with protocol m, one room 248 is used to prevent undue complexity within FIG. 2.

Guest room 248 has a set-top box 250. Set-top box 250 is connected at 254a and/or 254b to a universal television 252. Set-top box 250 utilizes command data protocol m and a protocol translation module 256 within universal television 252 is set to translate command data protocol m into command data under IM TV protocol as described above in conjunction with the previous figures. A hotel guest can use a remote control 238 to send a command 260 to make the universal television perform a function. As described above, universal television 252 passes the command 260 through to the set-top box 250. Set-top box 250 sends the command to the universal television 252 which is then translated at 256 resulting in the universal television 252 performing the desired function.

In the example of FIG. 2, the universal televisions 212, 232, and 252 are the same universal television, even though each is being commanded by a different ECU operating with a different command data protocol. Thus, in this example of a hotel, the same universal television can be used to interface with n different set-top boxes. This functionality enables a hotel to save money by retaining its legacy set-top boxes and televisions, while having choices for new purchases that span a range of set-top boxes since the universal television is not limited to a particular set-top box.

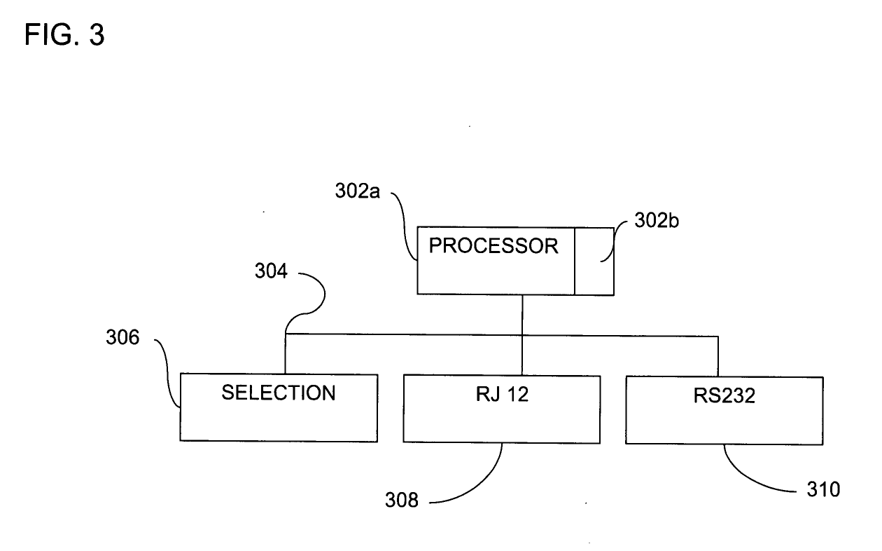

FIG. 3 illustrates, generally at 300, a command data protocol translation block according to embodiments of the invention. With reference to FIG. 3, one embodiment of a protocol translation module is shown in more detail at 300. A main processor 302a has a memory 302b, the processor 302a is connected to a buss 304. Buss 304 has connected thereto communication ports such as 310 utilizing RS232, and 308 utilizing RJ12. 308 is used to pass through the command received from a television remote control to an external control unit (ECU), such as infrared (IR) control commands from a handheld remote control operated by a user of the television. 306 is used to specify a particular command protocol that will be received from a particular ECU (set-top box) and provides an input for processor 302a. 306 can be in various embodiments, data read from a file, a bit setting, a dip switch setting, etc. Processor 302a can be an NEC quad-core Cortex processor, etc. Embodiments of the invention are not limited by the processor used to perform the functions described herein and the NEC model given herein is merely an example of one of many processors which can be used within embodiments of the invention.

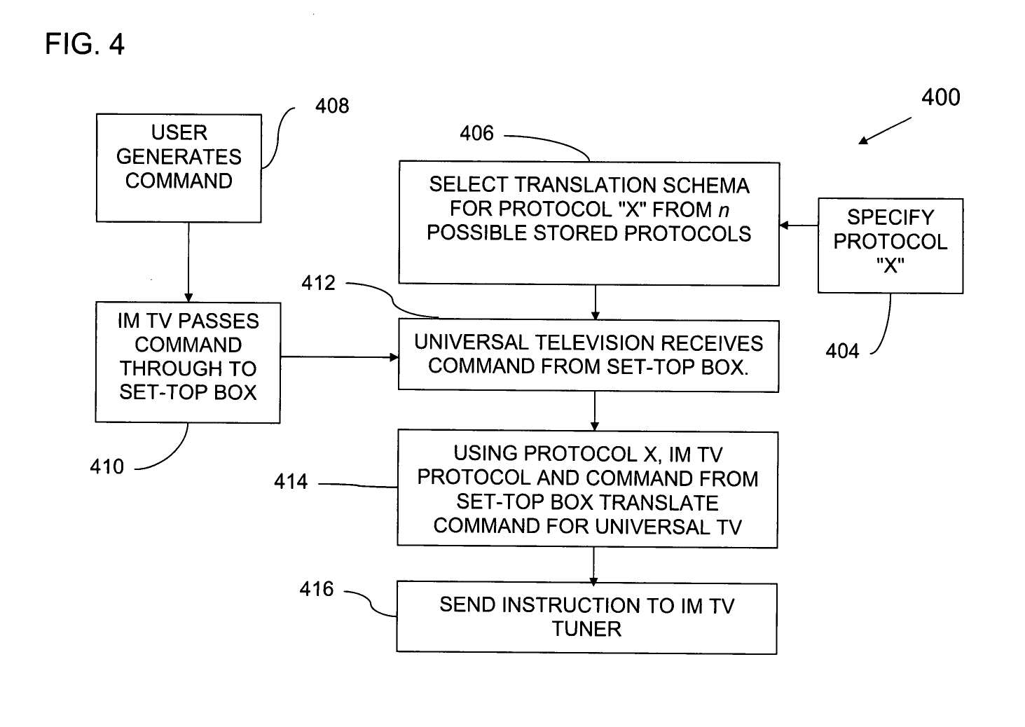

FIG. 4 illustrates, generally at 400, a system for protocol translation according to embodiments of the invention. With reference to FIG. 4, a system begins with a protocol “X” being specified from one of a general number of n protocols at a block 404. At a block 406, a translation schema is identified for use based on the specification of protocol “X” from the block 404. A user generates a television command at 408. The command can be generated using a handheld remote control supplied by the set-top box manufacturer. The universal television passes the command through to the set-top box at a block 410. At a block 412 a protocol translation module in a universal television receives the command from the set-top box. The command is then translated into IM TV protocol and the IM TV command is sent to the universal television for execution. In some embodiments, a set-top box will utilize the IM TV command protocol. One non-limiting example of a set-top box that uses the IM TV command protocol is the set-top box from Enseo. Some non-limiting examples of set-top boxes that have protocols that require translation are the NXTV set top box, and the VDA protocol. Many other television command data protocols can be used within the embodiments described herein; no limitation is implied by the specific protocols listed.

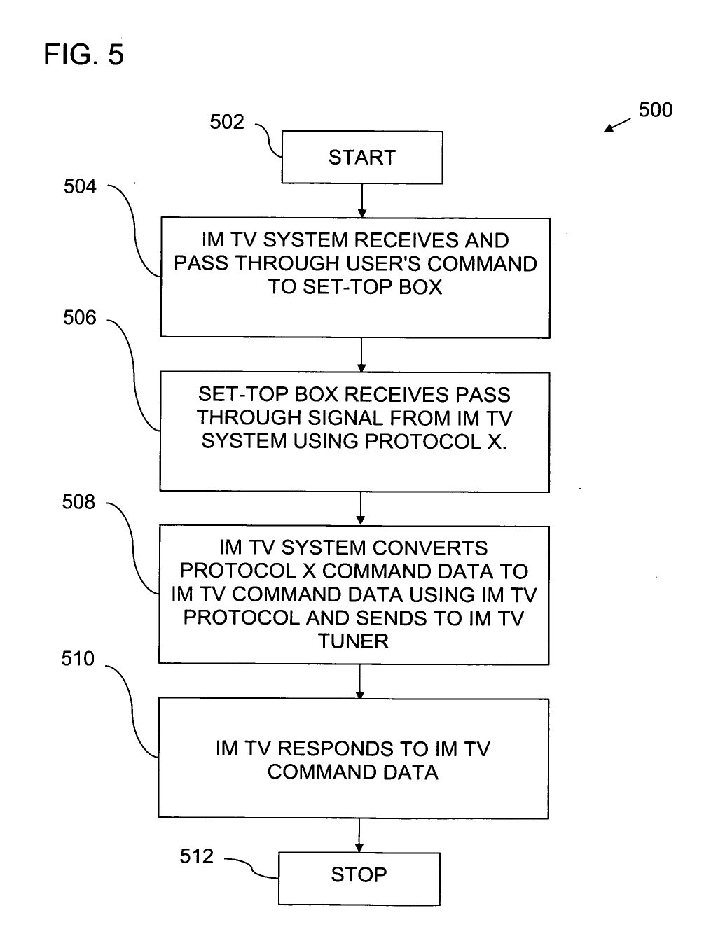

FIG. 5 illustrates, generally at 500, a process for protocol translation according to embodiments of the invention. With reference to FIG. 5, the process beings at a block 502. At a block 504, the universal television receives and passes through a user's television command (generally created by remote control) to an external control unit (ECU) connected to the television. At a block 506 the ECU receives the pass through command signal from the universal television and sends a command (utilizing protocol X) to the protocol translation module of the universal television. At a block 508 the protocol translation module converts the command received under protocol X to an IM TV command utilizing IM TV protocol. At a block 510 the IM TV command is sent to the universal television.

When a universal television is disconnected from the external control unit, the universal television goes into standalone mode. This occurs when the universal television has not received messages from the ECU within a preset period of time. While in standalone mode the universal television's protocol translation module continues to try to establish communication with the ECU. When communications between the universal television and the ECU are reestablished the protocol translation module goes back to external control mode.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus, comprising:
a memory;
a communications buss coupled to the memory;
a processor, the processor is coupled to the communications bus and the processor is programmed to:
receive a user command signal, the user command signal is initiated by a user of a television set;
pass the user command signal to an external control unit (ECU);
receive a television command signal from the ECU in response to the user command signal;
translate the television command signal into an IM TV protocol command, wherein a translation protocol is selected for the ECU from n possible translation protocols which are stored in the memory; and
transmit the IM TV protocol command to the television.

2. A method comprising:
receiving a user command signal;
passing the user command signal to an external control unit (ECU);
receiving a television command signal from the ECU in response to the passing;
translating the television command signal into an IM TV protocol command, wherein the translating selects a translation protocol from n possible translation protocols; and
transmitting the IM TV protocol command to a television.

3. The method of claim 2, further comprising:
updating the n possible translation protocols with an additional translation protocol to make n+1 translation protocol choices.

4. The method of claim 2, wherein the user command signal is generated from the user's handheld television control unit.

5. A computer readable medium containing executable computer program instructions, which when executed by a data processing system, cause the data processing system to perform a method comprising:
receiving a user command signal;
passing the user command signal to an external control unit (ECU);
receiving a television command signal from the ECU in response to the passing;
translating the television command signal into an IM TV protocol command, wherein the translating selects a translation protocol from n possible translation protocols; and
transmitting the IM TV protocol command to a television.
